(19) United States
(12) Patent Application Publication
(10) Pub. No.: US 2020/0125813 A1
(43) Pub. Date: Apr. 23, 2020

(54) SYSTEM AND METHOD OF NEAR FIELD TRACKING, FEEDBACK AND CONTROL

(71) Applicant: SAFETECH HOLDINGS LLC, Hammond, LA (US)

(72) Inventors: Brennan Scott Flores, Hammond, LA (US); Charles Robert Miller, Hammond, LA (US)

(21) Appl. No.: 16/656,087

(22) Filed: Oct. 17, 2019

Related U.S. Application Data
(60) Provisional application No. 62/746,695, filed on Oct. 17, 2018.

(51) Int. Cl. G06K 7/12; G06K 7/10; G06K 7/14

(52) U.S. Cl. CPC G06K 7/12; G06K 7/1413; G06K 7/10366

(57) ABSTRACT

The current system and method relate to a tracking and feedback system. More specifically, the system and method comprise a tracking apparatus attached to a tracked entity, reader nodes, a central management database including software platform, and a feedback system incorporated within the tracking apparatus and the central management database.

### BACKGROUND

The current system and method relate to a tracking and feedback system. More specifically, the system and method comprise a tracking apparatus attached to a tracked entity, reader nodes, a central management database including software platform, and a feedback system incorporated within the tracking apparatus and the central management database.

### SUMMARY

A system and method of tracking entities using current technology to include but not limited to RFID (active and passive), ultrasonic or infrared, barcode scanning, id tracking, digital lock and biometric lock. The system and method are designed to create custom zone area management to prevent exposure to potentially hazardous situations. In one form, a central management database is configured to delineate ‘zones of exposure’ using geofencing to restrict, limit access or track when a mobile device enters or leaves a particular area. The central management database includes a software platform and a feedback device that is attached or synchronized with a tracking apparatus. Rules and restrictions are added and may be updated real time, providing the ability to remotely access and control tracking devices.

In use, one form of system is incorporation of an RFID module into a hardhat, badge or safety vest to be worn by an individual that is identified as a tracking target. Other forms of tracking devices may be used such as a wristband equipped with an RFID tag and/or blood pressure monitoring sensor, body temperature sensor or pulse rate sensor. Designated zones are identified based upon geographic location, potential hazard working areas or positional spaces and rules of access are entered into the database. The rules can restrict or grant access to a certain geographic space according to GPS, facility, asset schematic, or other means as defined by the system administrator. This may include integration with certain equipment such as infrared beams and reader nodes, to automatically restrict certain zones or areas during various operations. When a tracked entity or target crosses into or near a designated zone, the system will analyze the rule base to determine, real time, whether the tracked target has permission to enter or be near the designated zone. Depending upon the rule base, the RFID module can produce visual, audio or tactical/haptic feedback to notify the wearer and/or administrator, via a feedback loop, of the real-time status of the target. The system provides tracking and tracing of modules with a feedback loop to a central administrator. The use of the system is highlighted in the oil and gas industry, both upstream and downstream, as well as in the construction industry.

The system has been designed to meet the challenging needs of the offshore oil and gas environment. While numerous advancements and efforts have been made on the proactive side of mitigating dropped objects and line of fire exposures, very few, if any have been as effective at protecting personnel as have exclusion zones. This system focuses on “engineering the exposure out” as outlined in the hierarchy of controls by means of geofencing.

One function of this system is to protect personnel from dropped objects and line of fire exposure in the upstream sector of the oil and gas industry. Dropped objects and line of fire exposures have been identified throughout the oil and gas industry as the number one risk to personal safety offshore. This system employs passive and active measures to help establish robust controls in mitigating drops and line of fire exposure. The usefulness of the system for the downstream sector is shown by the frequency of contract workers. With contract workers being on site especially during “turn around” periods where there is much room for human error, the system is used for tracking and controlling personnel assets and engineering out exposures from human error. A full “no-go” exclusion zone may be activated in refineries similar to the upstream sector as well as cautionary zones with high risk. In cautionary zones, vital personnel may be given permission to enter areas and others may be restricted. In the event of a barrier break, a sub-routine may be initiated depending on the rule set and whether or not the offender had the permission to enter the area.

The practical aspect of this system is to protect personnel that are present in or near danger zones, such as in the oil and gas industry, from dropped objects and line of fire exposure. As mentioned previously, dropped objects and line of fire exposures have been identified throughout the oil and gas industry as the number one risk to personal safety offshore. The system and method may also be used in a number of other industries without departing from the scope of this disclosure. The following is a description of the system and method.

Some of the key features of the system and method are as follows:
Integration: all facets of zone area risk and individual identification are integrated within this system. For example, the implemented program will monitor all zones of risk and will provide real time data. The program has the ability to link multiple zones as well as multiple tags and generate reports, providing real time tracking information of designated individuals, entities or equipment within zones of interest.
Accessibility of Information: all information is stored and readily available relating to users, zones, permissions and reports.
Configured to identify zones of interest, identify permissions within the zone of interest and tracking entities within or near the zone of interest including audible, visual and/or haptic feedback.

There is provided a system of tracking and communicating with a target in a designated zone, the system comprising a wearable badge member having a synchronization module and a battery, the badge member mounted to the target and synchronized with a central management database and at least one reader node, the central management database communicatively coupled with the badge member and at least one reader node, and at least one reader node positioned in the designated zone. The badge member may include a charging module, an alert module which may have visual, audio, tactical or haptic feedback and a wearer input module to include monitoring of vital signs, namely, a blood pressure monitoring sensor, a body temperature sensor, or a pulse rate sensor. The reader node has a determined tolerance level and multiple reader nodes with set tolerances may be placed in designated zone and the designated zone may include at least one infra-red sensor.

The system identifies barrier breaks and alerts a central database using at least one tag member synchronized with the central database, at least one reader node located near a designated zone and synchronized with the tag member, the at least one reader node synchronized with the central database, the tag member comprising an alert feature and the alert feature providing feedback information to the central database. The at least one reader node comprises a tiered barrier break system and the reader nodes are placed at designated access points for determined tolerance levels.

There is also provided a method of near field tracking, management and control of a target in a designated zone, the steps comprising identifying the designated zone, placing at least one reader node within or near the designated zone based upon tolerance modules, entering tracking data into a central management database, synchronizing the central management database with at least one tag module, connecting the at least one reader node and the at least one tag module with the central management database, and providing a feedback loop between the tag module, the reader node and the central management database. The feedback loop provides data on target and hazard locations with the reader node and target dimensionalized on the database.

### BRIEF DESCRIPTION OF THE DRAWINGS

FIG. 1 is an exploded view of one form of badge;

FIG. 2 is an alternate exploded view of FIG. 1;

FIG. 3 is a perspective view of a badge secured to a hard hat;

FIG. 4 is a schematic showing a form of badge module;

FIG. 5 is a data flow diagram including tags and reader nodes;

FIG. 6 is a schematic showing reader nodes combined with an infra-red sensor;

FIG. 7 is a flow diagram of the tracking system;

FIG. 8 is a flow diagram of the central computer server;

FIG. 9 is a flow diagram of a tracking system with infra-red capability; and

FIG. 10 is an illustration of a computing device.

### DETAILED DESCRIPTION

The system and method are directed to a form of tracking with feedback and more particularly toward a system and method of identifying zones of risk within an environment and placing signal devices such as reader nodes and infra-red beams within the area of risk, identifying individuals or equipment, hereinafter referred to generally as entities, that may enter the zone of risk and entering key information into a central database including identification of individuals or entities, synching identification tags with the central database and placement of tags on entities that have pre-set permissions within identified access points, alerting with a feedback system if a tag crosses a zone of risk, providing real time data on zone information as well as data visualization and reporting. The program is capable of tracking, alerting and managing tracked entities within identified zones. Oil rigs, construction sites as well as any other type of high-risk sites need to monitor data real time for managing zones of risk as well as entities entering the zones to ensure maximum compliance with precautions.

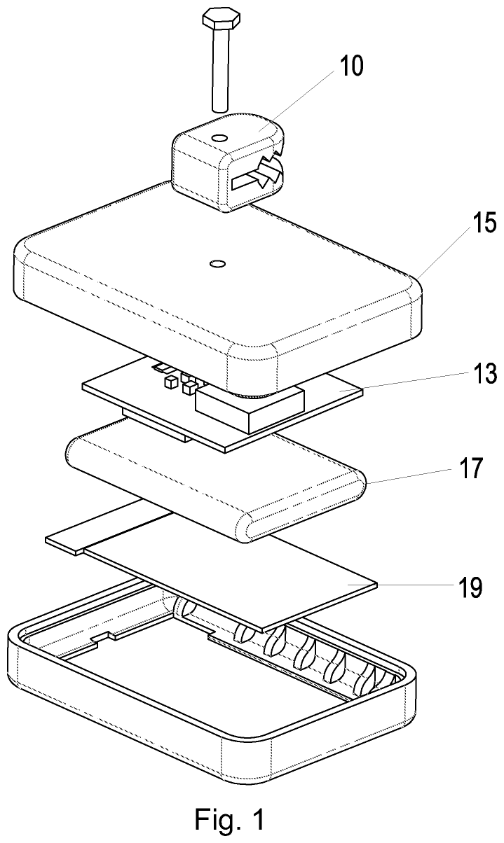

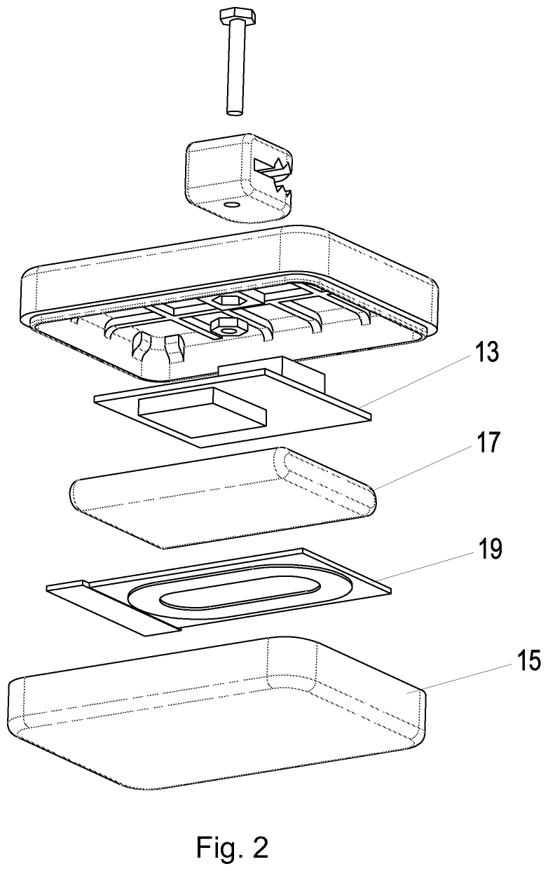

As shown in FIGS. 1-4, there is illustrated a rugged badge 15 worn by personnel or entities containing the communication module and the desired components. This embodiment is portable and can be attached with securing member 10 to clothing or equipment as necessary. The badge 15, in one form, is a rectangular plastic rugged housing and is designed to incorporate, preferably, a radio frequency module and provide tracking and feedback to the central system.

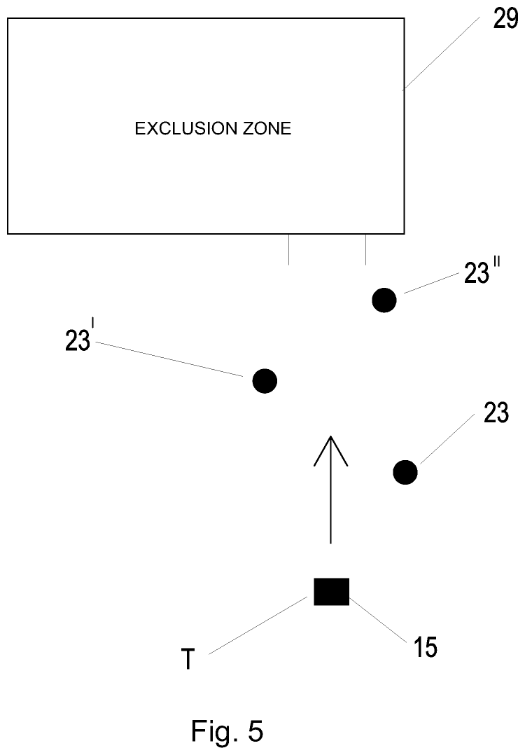

The badge includes a printed circuit board 13, that is a synchronization module, a lithium polymer rechargeable battery 17 and an inductive charger 19 which together comprise a charging module and are coupled to the device to charge the lithium battery and run the circuit board. As shown in FIG. 5, the battery 17 supplies power to the circuit board 13 which in turn provides data and ability to activate components 25. The components may include various alert modules such as a vibrating motor to provide haptic feedback, a siren to provide audible feedback, an LED to provide visual feedback and an optional button 27 for acknowledgment of feedback when the badge is activated. The circuit board 13 connects with a central management system 21 and Reader Nodes 23.

The central management system 21, to be discussed in further detail, can be set up with a system administrator that sets rules and permissions that may allow or restrict access for certain tracked entities within set geographic or positional spaces. An administrator can restrict or grant access to a certain geographic space according to GPS, facility or asset schematic, or other means as defined by the system administrator.

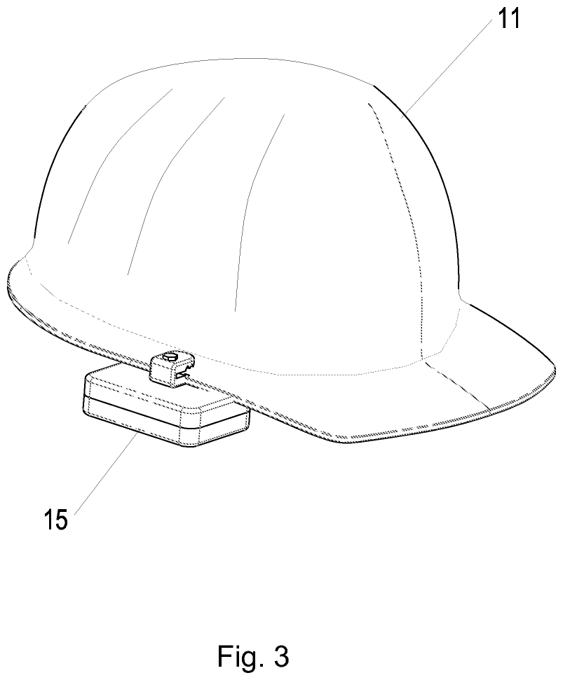

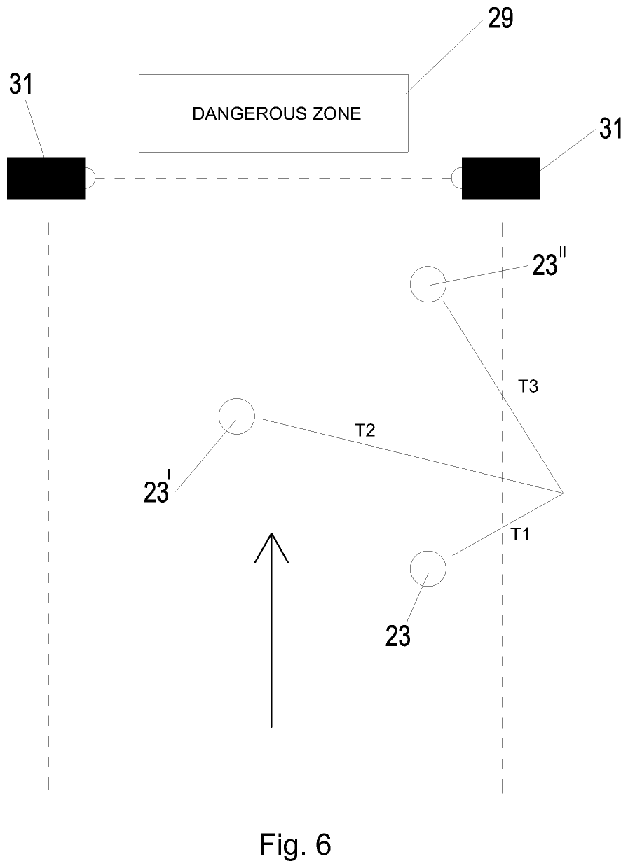

Once the zone of interest 29 is identified, as shown in FIGS. 5 and 6, the system will analyze the rule base and permissions to determine whether a tracked entity T that enters into this zone of interest has valid permissions to enter or leave the geographic space or zone of interest. This system check can also occur as an entity approaches a unique or grouped zone to predict what rule set would need to be enacted. Depending upon the calculation and subsequent result, the module 15 can produce visual, audio, or tactical feedback to notify the wearer and administrator of their permissions to enter or leave a newly entered or approaching zone. FIG. 3 shows a hardhat 11 containing a badge with an RFID module 13 secured to the hardhat and adapted to receive a signal. The hardhat/RFID module combination can be synchronized with a central database and can be tracked on an individual, group, or category basis—as determined by the system administrator. As mentioned previously, the RFID module is preferred but is not intended to limit the scope of the disclosure.

A second form of wearer input tag or module (not shown) is a wristband equipped with an RFID tag and/or blood pressure monitoring sensor, body temperature sensor, smart device and/or pulse rate sensor. This particular embodiment allows for direct contact with personnel making it possible to monitor vital signs, send text alerts and provide an audible alert.

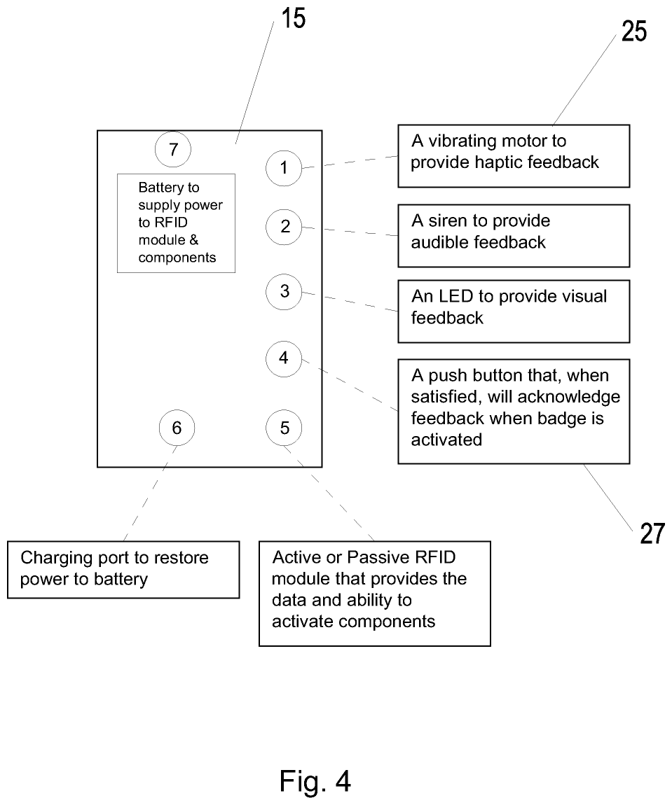

As mentioned above and shown in FIG. 4, the alert device may consist of a badge incorporating an RFID tag or module 13 that has the capability of notifying the user to various environmental conditions. The methods of notification can include but are not limited to:
i. A physical vibration on the embodiment of the tag
ii. A siren or alarm on the embodiment of the tag
iii. A visual identifier on the embodiment of the tag
iv. A siren or alarm on site of the facility that may be triggered by an alert from the tag
v. Haptic feedback including 3D touch as a form of communication
vi. A visual identifier on site including but not limited to
   a. A colored or uncolored monofilament light
   b. A colored or uncolored Light Emitting Diode (LED)
   c. Any visual identifier on the Graphical User Interface (GUI) used for the system including but not limited to a tablet or handheld device

For example, the above described badge 15 is shown in FIGS. 1-4 and is designed to house the RFID tag 13 which preferably is a combination of a charging system and custom printed circuit board (PCB) connected via surface mount directly to the board, allowing the tag to provide multiple forms of feedback to the user as well as the central database when a barrier has been broken or crossed. The forms of feedback, for example, audible, haptic and visual, will execute simultaneously when the tag receives a feedback signal from the central database that the barrier has been crossed. At that point, the user may press a reset button 27 to deactivate the tag or provide acknowledgement once the button is pressed.

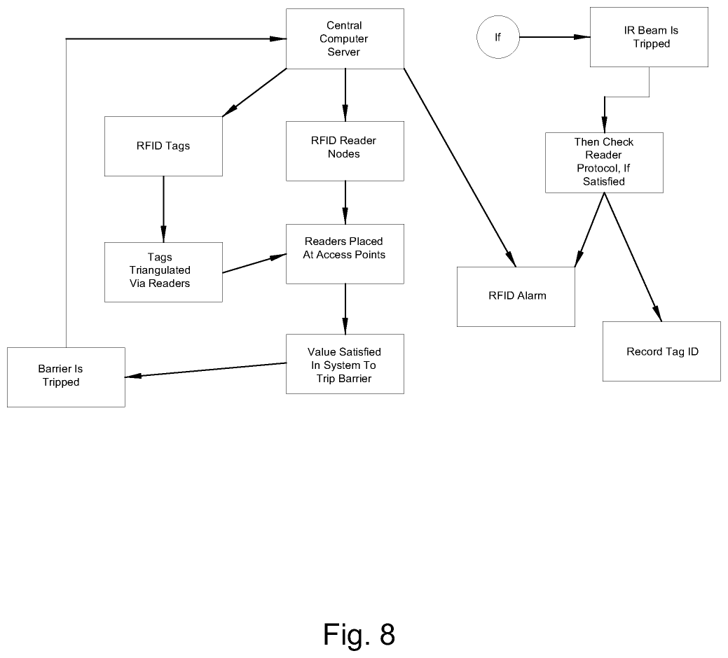

Referring to FIGS. 5, 6 and 7, in operation, the Reader Nodes 23, 23′ and 23″, through use of an ultra-high radio frequency, communicate with or search for any modules 13 or badges 15 located in the exclusion or detection zone 29 via signal strength to determine the location of the tag relative to the appropriate reader nodes in the area. The central server processes the data through a series of algorithms to determine the tag position similar to trilateration. In other words, the Reader Node(s) scan the zone of interest or exclusion zone 29 to determine the presence of RFID tags or badges 15. When a single or plurality of RFID tags 15 is or are detected, the information is read by the Reader Nodes(s) 23 and sent to the central management database or processor 21. The information on these tags 15 may include, but is not limited to, the name of the worker associated with the tag or the type of equipment involved, the identification of the tag (tagID) or the location of or distance between the tag with respect to the reader(s). The central management database then processes the information received from the Reader Node(s) 23 and a signal, indicating the detection of the badge 15, is transmitted to the tag via a communication interface such as a wireless interface or transceiver or a wired interface. FIG. 8 demonstrates the feedback loop between the Reader Node(s) 23, to be discussed in more detail, the RFID tags or badges, an infra-red beam 31 and the central system 21 in the event of a barrier break.

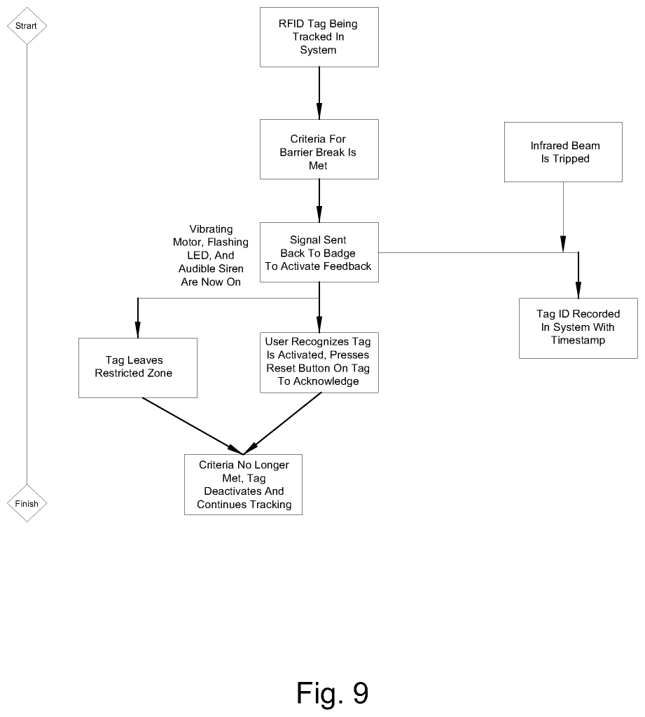

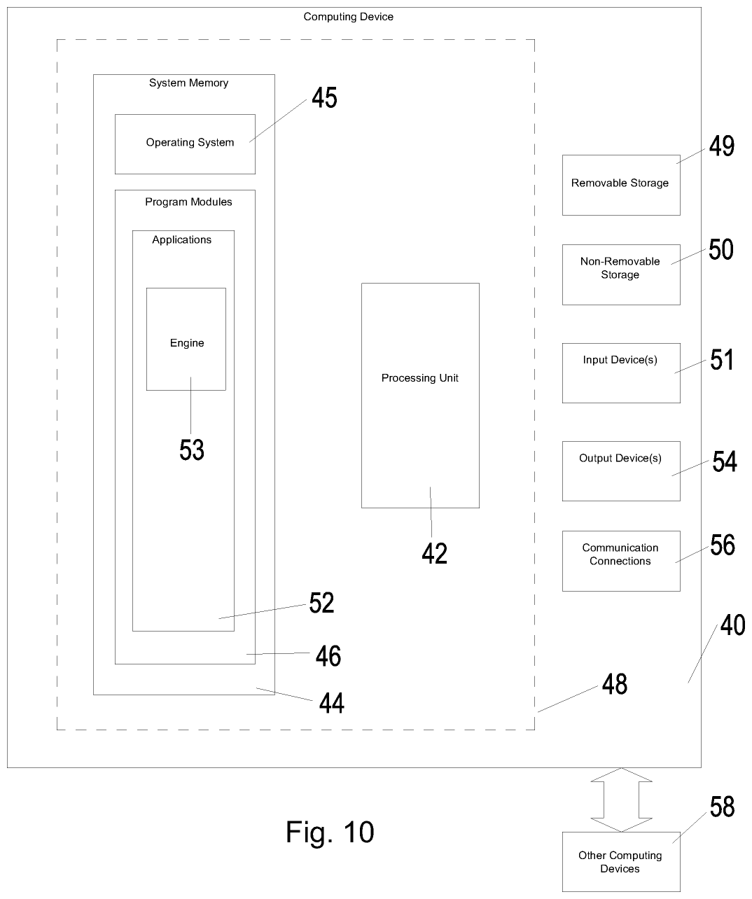

There are illustrated in FIGS. 9-11 data flow diagrams demonstrating the features of the method and system affording access to information stored pertaining to all transactions involved in the process of tracking entities and equipment in designated zones. Once relevant data is entered into the central database 21, there is a module for searching database information for a number of different variables. Personnel or equipment data may be filtered by date or status, for example. Information stored includes data categorized by date, type of personnel clearance, equipment status, safety and hazard information, zones of interest and incident history, to name a few but not by way of limitation.

A zone location feature may be integrated with a web-based program such as Google® maps incorporating variables such as the location of various identified zones. The system can receive daily location and tracking updates via GPS, for example, through use of trackers on the equipment or with personnel. When personnel, for example, are logged in, the following may be available: personnel location, hazard zone location, personnel details including clearance for identified zones, history of personnel and location, automated location update, zone breaches, personnel vital signs, etc. The system provides the ability to link multiple zones and personnel or equipment for a single site and the ability to generate a status report on personnel and/or equipment.

The system may also be integrated with certain equipment to automatically restrict certain zones or areas during various operations. Examples of integration with possible equipment may include but are not limited to:

i. Derrick mounted top drive

ii. Traveling block

iii. Crane boom

iv. “Charging” of iron lines

v. Iron roughnecks

vi. Casing perforation guns

Incorporation of a module or tag on one of the above allows tracking of the entity or equipment within zones of interest and providing audible or visual feedback to operators of such equipment regarding potential hazards in the area. Further, equipment may be tracked in workspaces for reasons other than hazard management. Equipment may also be tracked to determine location and operational status.

The system and method also function to allow tracking and tracing of personnel for accountability purposes. A badge 15 with an RFID module 13, for example, may be placed on an asset or entity giving a supervisor or administrator the real time tracking data of all entities or assets in a proposed zone or workspace during real emergency situations and or simulated emergencies/drills. The badge/RFID modules may also be equipped with various sensors to continuously monitor routine vital signs such as body temperature, pulse rate, and respiration rate to continuously relay the health and well-being of all entities within the system and generate real time health data.

A separate function of the system is the relaying of logistics reports during routine operations as well as secondary and tertiary operations. All or particularly selected entities and/or assets may be tracked throughout parts of or during an entire operation to generate the production of raw data that may be analyzed by the software or by the user or users of the system and further correlated to show possible improvements in efficiency of operations or organizational patterns and practices.

The subject matter of this application may be practiced in a variety of embodiments as systems, devices, and other articles of manufacture or as methods. Embodiments may be implemented as hardware, software, computer readable media, or a combination thereof. The embodiments and functionalities described herein may operate via a multitude of computing systems including, but not limited to, desktop computer systems, wired and wireless computing systems, mobile computing systems (e.g., cell phones, netbooks, tablets or slate type computers, notebook computers, and laptop computers), hand-held devices, multiprocessor systems, microprocessor-based or programmable consumer electronics, minicomputers, and mainframe computers.

User interfaces and information of various types may be displayed via on-board computing device displays or via remote display units associated with one or more computing devices. Interaction with the multitude of computing systems with which embodiments may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The figures provide illustrations of a variety of operating environments in which embodiments may be practiced. However, the devices and systems illustrated and discussed are for purposes of example and illustration and are not limiting of a vast number of computing device configurations that may be utilized for practicing embodiments of the invention described above. FIG. 11 is a block diagram illustrating physical components (i.e., hardware) of a computing device 40 with which embodiments of the system and method may be practiced. The computing device components may be suitable for embodying computing devices including, but not limited to, a personal computer, a tablet computer, a surface computer, and a smart phone, or any other computing device discussed herein.

In a basic configuration, the computing device 40 may include at least one processing unit 42 and a system memory 44. Depending on the configuration and type of computing device, the system memory 44 may comprise, but is not limited to, volatile storage (e.g., random access memory), non-volatile storage (e.g., read-only memory), flash memory, or any combination of such memories. The system memory 44 may include an operating system 45 and one or more program modules 46 suitable for running software applications 52 such as an engine 53 which may be configured implement one or more of the operations, features, processes or graphical user interface elements. The system may also include additional data storage devices 49 and 50 (removable and/or non-removable) such as, for example, magnetic disks, optical disks, or tape, input and output devices 51 and 54.

As stated above, a number of program modules and data files may be stored in the system memory 44. While executing on the processing unit 42, the software applications 52 may perform processes including, but not limited to, one or more of the processes, steps, features or functions. Other program modules that may be used may include electronic mail applications, database applications, or other conventional applications. Furthermore, embodiments may be practiced in an electrical circuit comprising discrete electronic elements, packaged or integrated electronic chips containing logic gates, a circuit utilizing a microprocessor, or on a single chip containing electronic elements or microprocessors. The computing device 40 may include one or more communication connections 56 allowing communications with other computing devices 58. Examples of communication connections 56 include, but are not limited to, RF transmitter, receiver, and/or transceiver circuitry; universal serial bus (USB), parallel, and/or serial ports.

The term computer readable media as used herein may include computer storage media. Computer storage media may include random access memory (RAM), read only memory (ROM), electrically erasable read-only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other article of manufacture which can be used to store information and which can be accessed by the computing device 40. Any such computer storage media may be part of the computing device 40.

The system may also include a radio that performs the function of transmitting and receiving radio frequency communications. The radio facilitates wireless connectivity between the system and the outside world via a communications carrier or service provider. Transmissions to and from the radio are conducted under control of the operating system. In other words, communications received by the radio may be disseminated to the application programs via the operating system, and vice versa. A visual indicator may be used to provide visual notifications, and/or an audio interface may be used for producing audible notifications via an audio transducer.

In one form, the visual indicator can be a light emitting diode (LED) and the audio transducer is a speaker. These devices may be directly coupled to a power supply so that when activated, they remain on for a duration dictated by the notification mechanism even though the processor and other components might shut down for conserving battery power. The LED may be programmed to remain on indefinitely until the user takes some action to indicate the powered-on status of the device. The audio interface may be used to provide audible signals to and receive audible signals from the user. For example, in addition to being coupled to the audio transducer, the audio interface may also be coupled to a microphone to receive audible input, such as to facilitate a telephone conversation. The microphone may also serve as an audio sensor to facilitate control of notifications. The system may further include a video interface that enables an operation of an on-board camera to record still images, video streams, and the like.

Data/information generated or captured may be stored via the system or the data may be stored on any number of storage media that may be accessed by the device via the radio or via a wired connection between the badge or tag and a separate computing device associated with the tag, for example, a server computer in a distributed computing network, such as the Internet. As should be appreciated such data/information may be accessed via the badge via the radio or via a distributed computing network. Similarly, such data/information may be readily transferred between computing devices for storage and use according to well-known data/information transfer and storage means, including electronic mail and collaborative data/information sharing systems. The central management database can be updated from time to time to add rules and restrictions to tracked apparatuses inside the system. The updates will occur in real time to enable an administrator to track and control the movements of the tracked entities.

In use, there are preferably four major hardware components:

1. Communication Tags

2. Reader Nodes

3. PC Reader

4. Alarm or Alert Module

The communication tags (also described as badges preferably incorporating RFID modules) 15 may be given a unique character ID and dimensionalized on the software platform. Reader Node(s) 23 are mounted at entrances or selected locations and dimensionalized on the software platform. The PC Reader relays data from the Reader Node(s) 23 to the software routine, which then gives a live feed of all entities equipped with an RFID Tag via the positioning algorithms in the software previously described to show the position of the tag relative to the Reader Node 23 in closest proximity. A schematic of the work area may be drafted and integrated into the software platform to provide a live visual display of the system performing tracking and controlling functions including the personnel tracking aspect of the system. The GUI also has the ability for the administrator or supervisor to activate selected reader nodes restricting access for certain or all RFID tags executing the function of an exclusion zone. Geo-fencing may be used to set up a secure perimeter with a virtual fence that provides information about entry and exit from a defined physical location. This requires Reader Nodes 23 and RFID tags or sensors in order to provide feedback information.

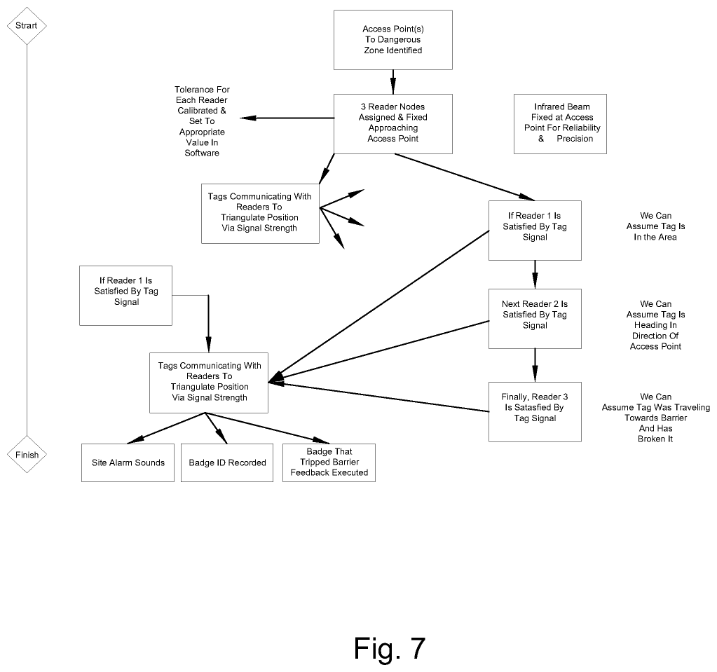

The sequencing of an access point provides the ability for geo-fencing the exclusion zone 29 while also having redundancies in place to avoid false barrier breaks with use of a tiered barrier break system. If all access points to an area are monitored then the entire area can be monitored. For example, as shown in FIGS. 6 and 7, Reader Nodes 23, 23′, 23″ may be applied in a sequence to an access point. Reader 1, 23 is preferably set at a given tolerance T1 and placed farthest away from the point of access at a distance ranging from 15 ft-35 ft from the desired zone. Reader 2, 23′ may be set at a given tolerance T2 and placed slightly closer to the access point. Reader 3, 23″ may be set at a given tolerance T3 and placed directly on the access point. With synchronization, these readers provide the ability to geo-fence the access point without throwing a false barrier break.

If an RFID tag exceeds the allowable tolerance for Reader 1 it can be assumed that the tag is in that area. If the same RFID tag exceeds the allowable tolerance for Reader 1 and then Reader 2, it can be assumed that the tag is approaching that access point. Finally, if an RFID tag exceeds the allowable tolerance for Reader 1, Reader 2, and Reader 3 in that order, it can be assumed that the RFID tag is in the location of the access point and has broken the barrier and the appropriate actions may be executed. The tolerance modules may be used in or near a designated zone and may be varied according to the desired tolerance in a designated zone or with a known target.

The addition of an infrared sensor 31 into the system is to provide greater reliability and precision. The use of the RFID sensors provides triangulation, meaning each reader calculates the location of the tag using the signal strength relative to it and ultimately can provide a location. The addition of the IR sensor 31 provides a “line” for a barrier. The RFID continues to track the location as described above and holds the raw data (name of work, position, etc.), but once the criteria for the readers is satisfied in the software system, permission is given for the IR beam to be tripped and once the beam is tripped, the tag ID can be recorded as the one that tripped the system. For example, as shown in FIGS. 7-10, if an individual with an RFID tag is traveling towards an excluded zone or dangerous zone 29, they activate the first RFID reader signaling that the tag is in the area. If the next reader is triggered, it provides information that the tag is traveling towards the exclusion zone. Finally, if the tag triggers the third and final reader, the tag has broken the barrier. The system will then detect the signal from the IR beam that it is broken, the appropriate processes within the software can take place such as sounding the alarm, recording of the badge, and alerting the central database as well as communicating with the tracked entity.

The foregoing description has been presented for purposes of illustration and description. It is not intended to be exhaustive nor to limit the method and system to the precise forms disclosed. Many alternatives, modifications, and variations will be apparent to those skilled in the art in light of the above. Accordingly, the method and system disclosed are intended to embrace all alternatives, modifications, and variations that fall within the spirit and broad scope of the claims.

We claim:

1. A system of tracking and communicating with a target in a designated zone, the system comprising:
a wearable badge member having a synchronization module and a battery;
said badge member mounted to said target and synchronized with a central management database and at least one reader node;
said central management database communicatively coupled with said badge member and said at least one reader node; and
said at least one reader node positioned in said designated zone.

2. The system according to claim 1 wherein said badge member includes a charging module.

3. The system according to claim 1 wherein said badge member includes an alert module.

4. The system according to claim 3 wherein said alert module includes visual, audio, tactical or haptic feedback.

5. The system according to claim 1 wherein said badge member includes a wearer input module to include monitoring of vital signs, namely, a blood pressure monitoring sensor, a body temperature sensor, or a pulse rate sensor.

6. The system according to claim 1 wherein said at least one reader node has a determined tolerance level.

7. The system according to claim 6 wherein multiple reader nodes with set tolerances are placed in said designated zone.

8. The system according to claim 1 wherein said designated zone includes at least one infra-red sensor.

9. A system of identifying barrier breaks and alerting a central database comprising:
at least one tag member synchronized with said central database;
at least one reader node located near a designated zone and synchronized with said tag member;
said at least one reader node synchronized with said central database;
said tag member comprising an alert feature and said alert feature providing feedback information to said central database.

10. The system according to claim 9 wherein said designated zone includes at least one infra-red beam.

11. The system according to claim 9 wherein said at least one reader node comprises a tiered barrier break system.

12. The system according to claim 11 wherein said reader nodes are placed at designated access points for determined tolerance levels.

13. A method of near field tracking, management and control of a target in a designated zone, the steps comprising:
identifying said designated zone;
placing at least one reader node within or near said designated zone based upon tolerance modules;
entering tracking data into a central management database;
synchronizing said central management database with at least one tag module;
connecting said at least one reader node and said at least one tag module with said central management database; and
providing a feedback loop between said at least one tag module, said at least one reader node and said central management database.

14. The method according to claim 13 wherein said method includes incorporating an infra-red sensor.

15. The method according to claim 13 wherein said tracking data includes permissions for said target.

16. The method according to claim 13 wherein said feedback loop provides data on said target location.

17. The method according to claim 13 wherein said feedback loop provides data on hazard locations.

18. The method according to claim 13 wherein said at least one reader node may be set at variable tolerances.

19. The method according to claim 13 wherein said at least one tag module provides signaling to said target.

20. The method according to claim 13 wherein said at least one tag module and said at least one reader node are dimensionalized on said database.
